(19) United States
(12) Patent Application Publication
(10) Pub. No.: US 2020/0265390 A1
(43) Pub. Date: Aug. 20, 2020

(54) TICKET DISPLAYING DEVICE, KEY DATA SERVER, AND TICKET DATA SERVER

(71) Applicant: DWANGO Co., Ltd., Tokyo (JP)

(72) Inventors: Nobuo KAWAKAMI, Tokyo (JP); Kenta TAKAHASHI, Tokyo (JP)

(73) Assignee: DWANGO Co., Ltd., Tokyo (JP)

(21) Appl. No.: 16/645,682

(22) PCT Filed: Sep. 6, 2018
(86) PCT No.: PCT/JP2018/032990

§ 371 Date: Mar. 9, 2020

(30) Foreign Application Priority Data
Sep. 8, 2017 (JP) 2017-173008

(51) Int. Cl. G06Q 20/04; G06Q 10/02; G06F 21/32

(52) U.S. Cl. CPC G06Q 20/0457; G06K 7/1417; G06F 21/32; G06Q 10/02

(57) ABSTRACT

In a first aspect of the present invention, a ticket displaying device includes a clock unit, a receiving unit, a generating unit, and a display unit. The clock unit indicates the date and time. The receiving unit receives key data. The generating unit generates first ticket image data for authenticating admission rights on the basis of the date and time indicated by the clock unit and key data. The display unit displays the first ticket image data. The first ticket image data displayed on the display unit changes over time based on the date and time indicated by the clock unit. The first ticket image data displayed on the display unit shows the same changes over time as second ticket image data which is displayed by another ticket displaying device for authenticating the same admission rights as the first ticket image data.

### TECHNICAL FIELD

The present invention relates to an electronic ticket.

### BACKGROUND ART

At entrance gates to event venues and movie theaters, visitors are checked to determine whether they have admission rights so that visitors who have not purchased tickets are not admitted (admission management).

Admission is typically managed by ripping paper tickets. Instead of ripping paper tickets, admission is sometimes managed by reading a QR code (registered trademark) printed on a paper ticket or reading a QR code displayed on a smartphone using a reader.

In Document 1 (JP 2016-071544 A), a terminal device 1 updates an electronic ticket based on signal identifying information from a signal generating device 2 only when the electronic ticket has been used ([0044]) and information is displayed on a display unit in the form of an updated icon that can be quickly viewed ([0045]). The information displayed on the display unit can be moving information such as video or information received from a ticket management server 3 ([0031]).

Document 2 (“QR codes are outdated! The new “ColorSync” electronic ticket for the 21st century allows people to see in color,” [online], Dec. 13, 2013, [search: Jul. 12, 2016], internet <URL: http://jp.techcrunch.com/2013/12/13/peatix-to-reinvent-e-ticketing-with-colorsync/>) discloses a technique in which the background color on the smartphone or tablet of a visitor to an event randomly changes in one-second intervals in synchronization with a server to quickly enable visitors to be admitted.

### SUMMARY OF INVENTION

A flood of visitors is sometimes admitted to large-scale events in a short period of time. This raises issues of visitor safety and convenience, and measures are desired for reducing traffic in and around entrance gates. More specifically, if individual visitors have to be admitted in a short period of time, traffic should be reduced to allow for smooth entry of visitors. Admitting one visitor per second is desired based on the number of visitors and the number of entrance gates.

When QR codes are read using a reader, chaos caused by reader errors and reader malfunctions is always a concern. QR codes can also be counterfeited using the screenshot function to enable unauthorized entry. Ripping tickets requires admission administrators to perform a series of operations for each visitor admitted, including taking the ticket, reading the ticket, ripping the ticket, and giving the stub back to the visitor.

The technique described in Document 1 eliminates the need to hand over a ticket to be ripped up, and may reduce the amount of time required to admit visitors. However, reading a QR code in this technique is similar to ripping a ticket, and still requires organization in which a single visitor is admitted at a time. Therefore, it can be difficult to reduce the amount of time required to admit each visitor to an event.

In the technique described in Document 2, the background color on the terminal of a visitor changes in short one-second intervals in synchronization with a server. If there is not precise synchronization of terminals with a server, the background color on the terminals of visitors may change rapidly on different timings. This increases the burden on admission administrators who must view each terminal. The speed of handling visitors slows down and ticket holders may be erroneously treated as unauthorized entrants.

It is an object of the present invention to reduce the time required to manage the admission of each visitor by enabling the admission of multiple visitors all at once.

In a first aspect of the present invention, a ticket displaying device includes a clock unit, a receiving unit, a generating unit, and a display unit. The clock unit indicates the date and time. The receiving unit receives key data. The generating unit generates first ticket image data for authenticating admission rights on the basis of the date and time indicated by the clock unit and key data. The display unit displays the first ticket image data. The first ticket image data displayed on the display unit changes over time based on the date and time indicated by the clock unit. The first ticket image data displayed on the display unit shows the same changes over time as second ticket image data displayed on another ticket displaying device for authenticating the same admission rights as the first ticket image data.

In a second aspect of the present invention, a ticket displaying device includes a clock unit, a sending unit, a receiving unit, and a display unit. The clock unit indicates the date and time. The sending unit sends a download request for ticket image data for authenticating admission rights to a server when predetermined conditions are satisfied. The receiving unit receives first ticket image data for authenticating admission rights from the server. The display unit displays the first ticket image data. The first ticket image data displayed on the display unit changes over time. The first ticket image data has display timing controlled on the basis of the date and time indicated by the clock unit. The first ticket image data displayed on the display unit shows the same changes over time as second ticket image data displayed on another ticket displaying device for authenticating the same admission rights as the first ticket image data.

In a third aspect of the present invention, a key data server includes a sending unit. The sending unit sends first key data to a first ticket displaying device associated with a first user having admission rights and sends second key data to a second ticket displaying device associated with a second user having the same admission rights as the first user. The first image data generated and displayed by the first ticket displaying device on the basis of the first key data and the date and time indicated by the clock unit inside the first ticket displaying device displays the same changes over time as second ticket image data generated and displayed by the second ticket displaying device on the basis of the second key data and the date and time indicated by the clock unit inside the second ticket displaying device.

In a fourth aspect of the present invention, a ticket data server includes a receiving unit and a sending unit. The receiving unit receives a download request for ticket image data for authenticating admission rights from a first ticket displaying device and a second ticket displaying device. The sending unit sends first ticket image data and second ticket image data to the first ticket displaying device and the second ticket displaying device. The first ticket displaying device controls the display timing of the first ticket image data on the basis of the date and time indicated by the clock unit inside the first ticket displaying device. The second ticket displaying device controls the display timing of the second ticket image data on the basis of the date and time indicated by the clock unit inside the second ticket displaying device. The first ticket image data displayed by the first ticket displaying device shows the same changes over time as the second ticket image data displayed by the second ticket displaying device.

The present invention is able to reduce the time required to manage the admission of each visitor by enabling the admission of multiple visitors all at once.

### BRIEF DESCRIPTION OF DRAWINGS

FIG. 1 is a block diagram showing the electronic ticket system in a first embodiment of the present invention.

FIG. 2 is a block diagram showing a ticket displaying device in FIG. 1.

FIG. 3 is a diagram showing the changes over time in ticket image data displayed on the ticket displaying device in FIG. 2.

FIG. 4 is a block diagram showing the key data server in FIG. 1.

FIG. 5 is a flowchart showing the operations performed by the ticket displaying device in FIG. 2.

FIG. 6 is a flowchart showing the operations performed by the key data server in FIG. 4.

FIG. 7 is a block diagram showing the electronic ticket system in a second embodiment of the present invention.

FIG. 8 is a block diagram showing a ticket displaying device in FIG. 7.

FIG. 9 is a block diagram showing the ticket data server in FIG. 7.

FIG. 10 is a flowchart showing the operations performed by the ticket displaying device in FIG. 8.

FIG. 11 is a flowchart showing the operations performed by the ticket data server in FIG. 9.

### DESCRIPTION OF EMBODIMENTS

The following is a detailed description of embodiments of the present invention with reference to the drawings. In the following explanation, elements identical or similar to those that have been explained already are denoted by the same or similar reference numbers and redundant explanation of these elements is essentially omitted. When there is more than one element that is identical or similar, the same reference numbers or the same reference numbers with branch numbers are used to indicate that the same description applies to all of these elements.

### 1st Embodiment

In the electronic ticket system in the first embodiment of the present invention, an electronic ticket is provided to a ticket purchaser to authorize admission to a certain location such as an event venue or movie theater. More specifically, the ticket displaying device of the ticket purchaser is used to download key data from a key data server. The ticket displaying device then generates and displays ticket image data to authorize admission to a certain location based on key data and the date and time indicated by the clock unit inside the ticket displaying device. In this way, the ticket displaying device functions as an electronic ticket. The image data including the ticket image data does not have to be a still image. It can be any visually appealing information including video or text that can be displayed on a display device such as a liquid crystal display screen.

The displayed ticket image data changes over time based on the time and date indicated by the clock unit. This makes it difficult to forge ticket image data based on an illicit screenshot. The change in the displayed ticket information data is the same as the change that occurs on other ticket displaying devices. Admission administrators can then admit individual visitors in a shorter amount of time simply by glancing at the ticket image data displayed on the ticket displaying devices of visitors.

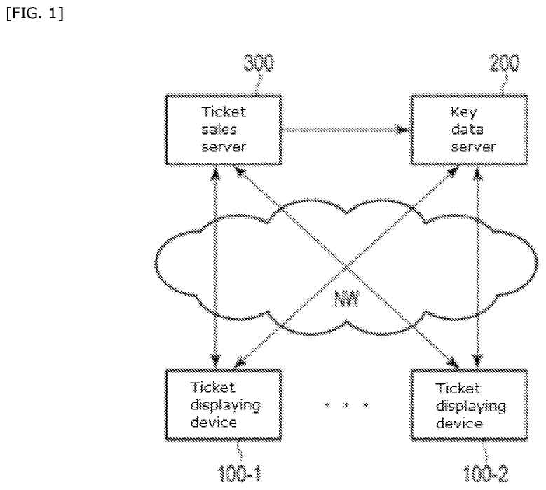

As shown in FIG. 1, the electronic ticket system in the present embodiment includes ticket displaying devices 100-1, 100-2, a key data server 200, and a ticket sales server 300. Each ticket displaying device 100 is connected via a network to the key data server 200 and the ticket sales server 300. For the sake of simplicity, the number of ticket displaying devices 100 is limited to two but the number may be three or more. The server configuration depicted in FIG. 1 is for illustrative purposes only and the functions of this single server may be divided among a plurality of devices or the functions of a plurality of servers can be integrated into a single device.

The ticket displaying devices 100 access the ticket sales server 300 and authorization rights to a given location are acquired by purchasing a ticket. Tickets can be purchased using any existing electronic commerce (EC) technique. The ticket sales server 300 sends ticket purchaser information such as ticket purchaser identifying information (for example, identifying information such as an account name associated with the user in the electronic ticket system in FIG. 1) and identifying information on the ticket displaying device 100 used when the ticket was purchased to the key data server 200, and issues a key data request to the key data server 200.

When the key data server 200 receives the key data request from the ticket sales server 300, it issues key data based on the request and sends the key data to the ticket displaying device 100 of the ticket purchaser.

The ticket displaying device 100 receives the key data from the key data server 200 and generates and displays ticket image data based on the key data and the date and time indicated by the clock unit inside the ticket displaying device 100. The displayed ticket image data changes over time based on the date and time indicated by the clock unit. This makes it difficult to forge ticket image data based on an illicit screenshot.

The change over time in the ticket image data displayed on the ticket displaying device 100 is the same as the change over time in the ticket image data displayed on other ticket displaying devices 100. An admission administrator can then reference the ticket image data currently being displayed on the ticket displaying device 100 or some other means. This allows admission administrators to admit visitors simply by glancing at the screens of ticket displaying devices 100 when a plurality of visitors present their ticket displaying devices 100 to admission administrators. For example, if there are five people in each group, each group of visitors can be admitted in about three seconds or in about 0.6 seconds per visitor. When a visitor presents a ticket displaying device 100 with a screen display that is out of place, an admission administrator can simply call the owner of the device out of line without having to scrutinize the screen for admission rights. They can be directed to a window to purchase a paper ticket or to a special admission gate so that other visitors can be handled without delay.

The following is a description of the configuration and explanation of the operation of the ticket displaying devices 100 and the key data server 200 in FIG. 1. First, the configuration of the ticket displaying device 100 will be described. The ticket displaying device 100 is typically a mobile terminal (for example, a tablet, smartphone, laptop, feature phone, portable game console, digital music player, or e-book reader), but there are no particular restrictions.

The ticket displaying device 100 includes a processor such as a central processing unit (CPU) for controlling ticket purchases, ticket image data generation, communication, and information display, and memory for temporarily storing programs executed by the processor and data used by the processor to realize this processing.

The ticket displaying device 100 can use a communication device connected to a network and a display device for displaying ticket image data. The communication device and display device may be built into the ticket displaying device 100 or attached to the ticket displaying device 100.

The communication device communicates with external devices such as the key data server 200 and the ticket sales server 300 via a network. More specifically, the communication device exchanges information with the ticket sales server 300 required to make a ticket purchase and downloads key data from the key data server 200. In the explanation provided above, the ticket sales server 300 sent a key data issuing request to the key data server 200, but the ticket displaying device 100 can send a key data issuing request to the key data server 200 instead.

The display device displays video, still images, and text. The display device may be a liquid crystal display, an organic electroluminescence (EL) display, or a cathode ray tube (CRT). The display device may include the functions of an input device such as a touch screen.

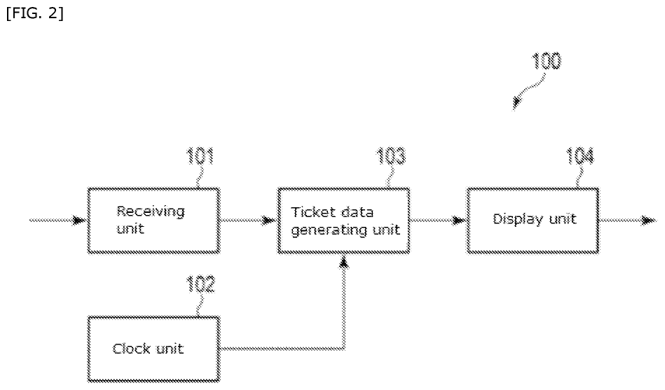

The configuration of the ticket displaying device 100 will now be described using FIG. 2. The ticket displaying device 100 in FIG. 2 has a receiving unit 101, a clock unit 102, a ticket data generating unit 103, and a display unit 104.

The receiving unit 101 receives key data from the key data server 200 via the network. The receiving unit 101 sends the received key data to the ticket data generating unit 103. The key data, as described in detail below, can be a seed code used to generate a number or character string displayed on security tokens in a time-synchronized one-time password system or similar information. For algorithms used for time synchronized one-time passwords, see “RFC6238-TOTP: Time-based One-time Password Algorithm” (URL: https://tools.ietf.org/html/rfc6238). The receiving unit 101 may be a communication device described above or an interface with this communication device.

The clock unit 102 indicates the date and time. The clock unit 102 includes, for example, a crystal oscillator that vibrates at a fixed frequency, a frequency divider that performs frequency division on the output to obtain 1 Hz signals, and a counter that counts signals to obtain serial values indicating the date and time. The date and time indicated by the clock unit 102 are referenced by the ticket data generating unit 103.

The ticket data generating unit 103 acquires key data from the receiving unit 101 and references the date and time indicated by the clock unit 102. The ticket data generating unit 103 generates ticket image data for authenticating admission rights on the basis of key data and the date and time indicated by the clock unit 102 and sends the ticket image data to the display unit 104.

For example, the ticket data generating unit 103 obtains values by performing predetermined operations using a seed code based on the key data and the date and time indicated by the clock unit 102. The ticket data generating unit 103 then converts these values into the corresponding image data. For example, some of the values can be used as commands to determine the type of pattern in the image data or the color, design, and direction of the pattern.

The ticket data generating unit 103 may be the processor and memory described above. For example, the processor may execute an application for managing electronic tickets downloaded to the memory to function as a ticket data generating unit 103.

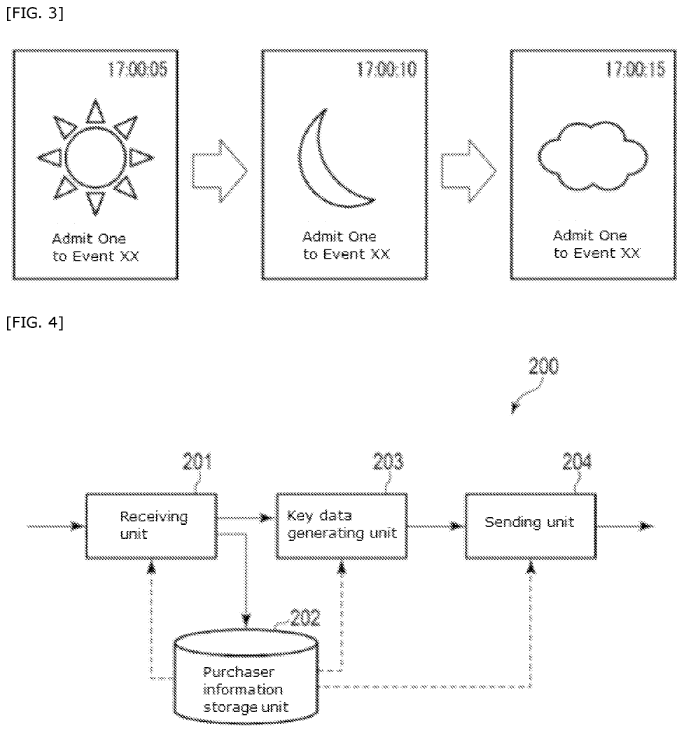

The ticket image data is image data that changes over time based on the date and time indicated by the clock unit 102. The ticket image data may have any pattern but is preferably a simple pattern that can be recognized at a glance by admission administrators. An example of ticket image data that changes over time is shown in FIG. 3. In the example shown in FIG. 3, the ticket image data changes from the sun to the moon and from the moon to a cloud every five seconds.

The changes to the ticket image data are not restricted to those shown in FIG. 3. The changes over time in the ticket image data may include changes in color, brightness, pattern, letters or numbers, or changes in the position or orientation of patterns, letters, or numbers. The ticket image data may also include a portion that does not change. For example, a portion of the ticket image data that does not change over time may be a portion indicating the event name, venue name, and event date and time. The ticket data generating unit 103 may control the change in the ticket image data over time so that the image data does not constantly appear the same from the outside. In this way, clues cannot be obtained about how the ticket image data will appear in the future by examining ticket image data that appeared in the past. This makes it difficult to forge ticket image data based on an illicit screenshot.

The interval at which the ticket image data changes can be shorter or longer than the five sections shown in FIG. 3. For example, it may change every minute as in the case of time synchronized one-time password systems. When the interval is too short, it may become more difficult for admission administrators to check the ticket image data at a glance. When the ticket image data changes over a period that is not long enough to allow admission administrators to compare the ticket image data currently being displayed to ticket image data being displayed on the ticket image displaying devices 100 of visitors, it may become difficult for them to determine whether ticket displaying devices 100 are displaying the ticket image data that should be currently displayed. Therefore, the interval can be set to be longer that the period of time required for admission administrators to admit a single group (for example, 3 seconds), or a visual effect can be retained that does not involve a change in the pattern itself, such as blinking ticket image data. When the interval is too long and the ticket image data does not change for a long period of time, it becomes less difficult to forge ticket image data based on an illicit screenshot.

The ticket image data used to authenticate admission rights changes over time in the same way as ticket image data being displayed on other ticket displaying devices 100. In other words, all ticket displaying devices 100 that have acquired the same admission rights can generate and display the same ticket image data. However, because the ticket image data changes over time based on the date and time indicated on the clock unit 102 built into each ticket displaying device 100, the change in ticket image data may be mistimed if the time on a clock unit 102 is off.

Because all ticket displaying devices 100 with the same admission rights can generate and display the same ticket image data, the same key data can be distributed to all ticket displaying devices 100 and the key data can be used as the seed code without further alteration. While this technique reduces the processing burden on the key data server 200 for generating key data, ticket image data may be more easily forged when the key data is released.

Therefore, the key data server 200 may generate unique key data for each ticket displaying device 100. More specifically, the ticket data generating unit 103 in each ticket displaying device 100 may derive a seed code by performing calculations on the key data distributed to the ticket displaying device 100 and unique information such as identifying information for the ticket purchaser or ticket displaying device 100. Here, the key data server 200 generates unique key data for each ticket displaying device 100 so that the same seed code is derived by all ticket displaying devices 100. Even when this key data is duplicated for other ticket displaying devices 100, the proper seed code calculations cannot be performed because the seed code calculation method remains unclear and this makes it more difficult to forge ticket image data.

The display unit 104 receives ticket image data from the ticket data generating unit 103 and displays the ticket image data. The display unit 104 may be a display device described above or an interface for one of those display devices.

As explained above, the timing for changing the ticket display data is mistimed if the time on the clock units 102 is off between ticket displaying devices 100. In other words, there is a possibility that the ticket image data displayed on the screen of the ticket displaying device 100 of a user with admission rights (a ticket purchaser or admission administrator) will not be the ticket image data that should be currently displayed but rather ticket image data before or after this ticket image data.

Therefore, the display unit 104 of at least one ticket displaying device 100, that of the visitor or the admission administrator, may display not only the current image data associated with the (current) time indicated by the clock unit 102 in the ticket displaying device 100, but also at least one past image data or future image data associated with a time before or after the current time. For example, the previous two versions of past image data and the subsequent two versions of the image data can be displayed. In this way, the admission process remains smooth even when there is a mismatch between the clock units 102 on the ticket displaying devices 100 of visitors and admission administrators. Here, the display unit 104 may display the past image data or the future image data side by side with the current image data or may display the past image data or future image data alternatingly with the current image data.

In order to keep the time from being off on clock units 102 between ticket displaying devices 100, the key data server 200 or ticket sales server 300 may note the mistiming of a clock unit 102 in a ticket displaying device 100 when accessed by the ticket displaying device 100 and prompt the device to reset the time if it is off.

An example of the configuration for the key data server 200 will now be described. The key data server 200 is a server computer including a processor for generating key data and controlling communication, and memory for temporarily storing a program executed by the processor and data used by the processor for realizing this processing.

The key data server 200 can use a communication device connected to a network and an auxiliary storage device for storing large amounts of data. The communication device and auxiliary storage device may be built into the key data server 200 or may be attached externally to the key data server 200.

The communication device communicates with ticket displaying devices 100 or the ticket sales server 300 via the network. For example, the communication device receives ticket purchaser information and key data issuing requests from the ticket sales server 300 and distributes key data to the ticket displaying devices 100.

The auxiliary storage device is used to store, for example, ticket purchaser information. The auxiliary storage device is preferably a non-volatile storage medium such as a hard disk drive (HDD) or solid-state drive (SSD). The auxiliary storage device may be a file server connected to the key data server 200 via a network.

The description of the example of a configuration for the key data server 200 will now be continued with reference to FIG. 4. The key data server 200 in FIG. 4 includes a receiving unit 201, a purchaser information storage unit 202, a key data generating unit 203, and a sending unit 204.

The receiving unit 201 receives ticket purchaser information and key data issuing requests from the ticket sales server 300. The key data issuing request may be sent by a ticket displaying device 100. In this case, the receiving unit 201 may authenticate ticket displaying devices 100 if necessary. The receiving unit 201 saves ticket purchaser information to a purchaser information storage unit 202 (not shown). The receiving unit 201 also sends the key data issuing request to the key data generating unit 203. The receiving unit 201 may be one of the communication devices described above or an interface for the communication device.

The purchaser information storage unit 202 receives ticket purchaser information from the receiving unit 201 and stores the information. The ticket purchaser information is referenced by the receiving unit 201 to authenticate a ticket displaying device 100, is referenced by the key data generating unit 203 to issue unique key data to a ticket displaying device 100, and is referenced by the sending unit 204 to set the address of the issued key data. The purchaser information storage unit 202 may be the auxiliary storage device described above or an interface for the auxiliary storage device.

The key data generating unit 203 receives a key data issuing request from the receiving unit 201 and generates key data based on this request. The key data may be a random number string and/or character string. When the same key data is distributed to all ticket displaying devices 100, the key data generating unit 203 may store the key data generated for an initial issuing request in a storage unit (not shown) and retrieve this key data for the second and subsequent issuing requests. When unique key data is generated for each ticket displaying device 100, the key data generating unit 203 retrieves ticket purchaser information from the purchaser information storage unit 202 and generates key data based on this information. The key data generating unit 203 sends the generated key data to the sending unit 204. The key data generating unit 203 may be the processor and memory described above.

The sending unit 204 receives key data from the key data generating unit 203 and sends this to a ticket displaying device 100 via a network. The sending unit 204 may be a communication device described above or an interface for one of these communication devices.

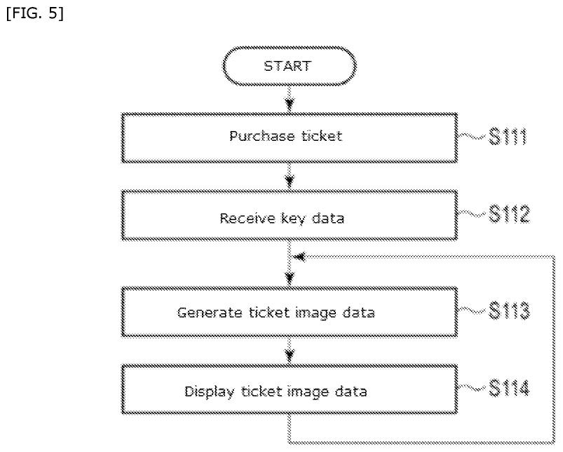

The following is an explanation of the operations performed by a ticket displaying device 100 with reference to FIG. 5. First, the ticket displaying device 100 accesses the ticket sales server 300 to purchase a ticket (Step S111). After Step S111, the ticket sales server 300 sends ticket purchaser information and a key data issuing request to the key data server 200. When a key data issuing request is received, the key data server 200 issues key data and distributes it to the ticket displaying device 100. The receiving unit 101 in the ticket displaying device 100 receives this key data (Step S112).

The ticket data generating unit 103 generates ticket image data based on the key data received in Step S112 and the date and time indicated by the clock unit 102 (Step S113). The display unit 104 displays the ticket image data generated in Step S113 (Step S114). The ticket image data displayed on the display unit 104 changes over time as Step S113 and Step S114 are repeated at a predetermined interval.

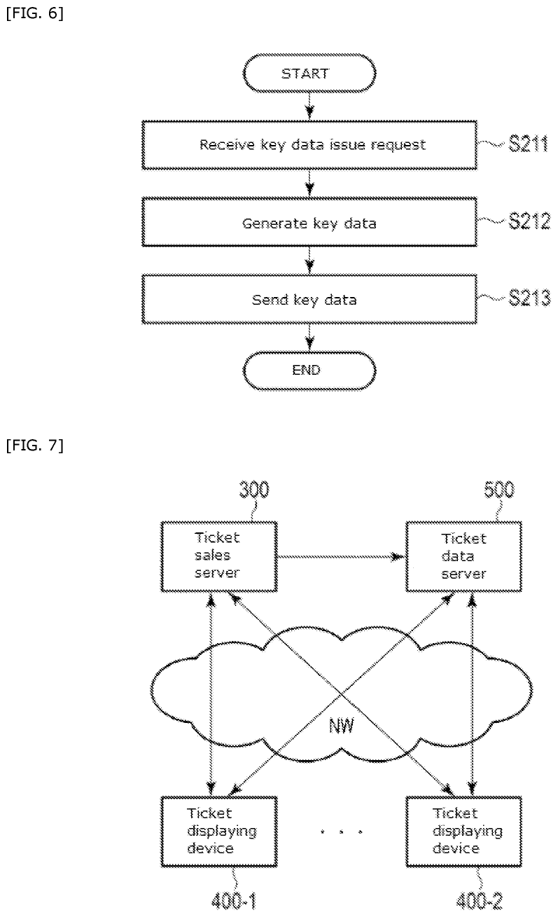

The following is an explanation of the operations performed by the key data server 200 with reference to FIG. 6. The receiving unit 201 receives a key data issuing request from the ticket sales server 300 (Step S211). The key data generating unit 203 generates key data in response to the issuing request received in Step S211 (Step S212). The sending unit 204 sends the key data generated in Step S212 (Step S213).

In the electronic ticket system in the first embodiment described above, the ticket displaying device of the ticket purchaser downloads key data, and ticket image data is generated based on this key data and the date and time indicated by the clock unit inside the ticket displaying device and then displayed. The ticket image data changes over time based on the date and time indicated by the clock unit. This ticket image data changes over time in the same way as ticket image data displayed on other ticket displaying devices used to authenticate the same admission rights as this ticket image data. In this electronic ticket system, admission administrators can manage the admission of a plurality of visitors simply by glancing at the screens of the ticket displaying devices of these visitors. Because the ticket image data changes over time, it is difficult to forge ticket image data based on an illicit screenshot.

Also, the display unit on the ticket displaying devices of the visitors and/or admission administrators may display not only the current image data associated with the (current) time indicated by the clock unit in the ticket displaying device, but also at least one past image data or future image data associated with a time before or after the current time. In this way, the admission process remains smooth even when there is a mismatch between the clock units on ticket displaying devices.

### 2nd Embodiment

In the electronic ticket system of a second embodiment of the present invention, as in the first embodiment, an electronic ticket is provided to ticket purchasers to authenticate admission rights to a certain location such as an event venue or movie theater. Here, the ticket displaying device of a ticket purchaser cannot download ticket image data for authenticating admission rights to a location unless certain conditions are satisfied such as being close to the location geographically or being close to the admission start time at the location. This makes it difficult to analyze and forge ticket image data beforehand. A ticket displaying device downloads and displays ticket image data when these conditions have been satisfied. In this way, the ticket displaying device functions as an electronic ticket.

Because the displayed ticket image data changes over time, it is difficult to forge ticket image data based on an illicit screenshot. The display timing for the ticket image data is controlled based on the date and time indicated by the clock unit and the change over time is the same as the change over time on other ticket displaying devices. Admission administrators can then admit individual visitors in a shorter amount of time simply by glancing at the ticket image data displayed on the ticket displaying devices of visitors.

As shown in FIG. 7, the electronic ticket system in the present embodiment includes ticket displaying devices 400-1, 400-2, a ticket data server 500, and a ticket sales server 300. Each ticket displaying device 400 is connected via a network to the ticket sales server 300 and the ticket data server 500. For the sake of simplicity, the number of ticket displaying devices 400 is limited to two but the number may be three or more. The server configuration depicted in FIG. 7 is for illustrative purposes only and the functions of this single server may be divided among a plurality of devices or the functions of a plurality of servers can be integrated into a single device.

The ticket displaying devices 400 access the ticket sales server 300 and authorization rights to a given location are acquired by purchasing a ticket. Tickets can be purchased using any existing electronic commerce technique. The ticket sales server 300 sends ticket purchaser information such as ticket purchaser identifying information (for example, identifying information such as an account name associated with the user in the electronic ticket system in FIG. 7) and identifying information on the ticket displaying device 400 used when the ticket was purchased to the ticket data server 500, and notifies the ticket displaying device 400 of the conditions for downloading ticket image data. Notifications of the conditions for downloading ticket image data may be provided by the ticket data server 500.

When the ticket displaying device 400 determines that the predetermined downloading conditions have been satisfied, a ticket image data download request is sent to the ticket data server 500. When a ticket image data download request is received from the ticket displaying device 400 of a ticket purchaser, the ticket data server 500 responds by sending ticket image data to the ticket displaying device 400.

The ticket displaying device 400 receives and displays the ticket image data from the ticket data server 500. The displayed ticket image data changes over time. As a result, it is difficult to forge ticket image data based on an illicit screenshot.

The display timing for the ticket image data is controlled based on the date and time indicated by the clock unit in the ticket displaying device 400 and the change over time is the same as the change over time in the ticket image data displayed on other ticket displaying devices 400. An admission administrator can then reference the ticket image data currently being displayed on the ticket displaying device 400 or some other means. This allows admission administrators to admit visitors simply by glancing at the screens of ticket displaying devices 400 when a plurality of visitors present their ticket displaying devices 400 to admission administrators.

The following is a description of the configurations and an explanation of the operations of the ticket displaying devices 400 and ticket data server 500 in FIG. 7. First, the configuration of the ticket displaying devices 400 will be described. The ticket displaying devices 400 are typically mobile terminals.

Each ticket displaying device 400 includes a processor such as a CPU for controlling ticket purchases, communication, and information display, and memory for temporarily storing programs executed by the processor and data used by the processor to realize this processing.

The ticket displaying device 400 can use a communication device connected to a network and a display device for displaying ticket image data. The communication device and display device may be built into the ticket displaying device 400 or attached to the ticket displaying device 400.

The communication device communicates with external devices such as the ticket sales server 300 and the ticket data server 500 via a network. More specifically, the communication device exchanges information with the ticket sales server 300 required to make a ticket purchase and downloads ticket image data from the ticket data server 500.

The display device displays video, still images, and text. The display device may be a liquid crystal display, an EL display, or a CRT display. The display device may include the functions of an input device such as a touch screen.

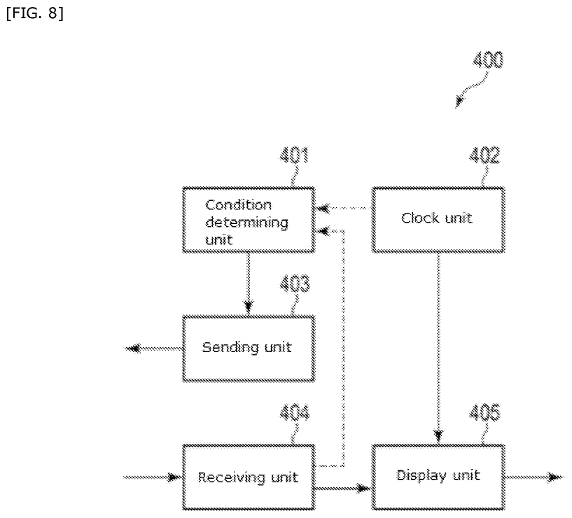

The configuration of the ticket displaying device 400 will now be described using FIG. 8. The ticket displaying device 400 in FIG. 8 has a condition determining unit 401, a clock unit 402, a sending unit 403, a receiving unit 404, and a display unit 405.

The condition determining unit 401 determines whether or not the ticket image data downloading conditions have been satisfied and notifies the sending unit 403 when the conditions have been satisfied. The ticket image data downloading conditions may be received from the ticket sales server 300 when a ticket is purchased or may be automatically set according to a predetermined algorithm based on the location of the venue or the admission start time.

The downloading conditions are used to determine how close a ticket holder is to using the admission rights authenticated by the ticket image data. By granting permission to download ticket image data only under certain conditions, ticket image data becomes more difficult to forge. The downloading conditions may include temporal conditions or geographic conditions. The downloading conditions may be satisfied within a predetermined time period prior to the admission start time at a venue, for example, one hour early, or may be satisfied within a predetermined distance of the venue, for example, 500 meters. A password may have to be entered at or near the venue.

The condition determining unit 401 may start an application for managing electronic tickets or determine whether downloading conditions have been satisfied when triggered by a user-entered download request for ticket image data. The conditions may also be determined based on predetermined timing. In order to determine whether downloading conditions have been satisfied, the condition determining unit 401 may use the date and time indicated by the clock unit 402, position information acquired from a position information acquiring unit (not shown) or user input acquired from an input unit (not shown). The position information may be GPS (Global Positioning System) information or beacon information.

A configuration corresponding to the condition determining unit 401 may be provided in the ticket data server 500. Position information on the ticket displaying device 400 and user input (such as a password) from the ticket displaying device 400 may be included in a ticket image data download request sent from a ticket displaying device 400. When the downloading conditions are temporal conditions, the ticket data server 500 may push ticket image data to the ticket displaying devices 400 of ticket purchasers after the downloading conditions have been satisfied.

The clock unit 402 indicates the date and time. The clock unit 402 includes, for example, a crystal oscillator that vibrates at a fixed frequency, a frequency divider that performs frequency division on the output to obtain 1 Hz signals, and a counter that counts signals to obtain serial values indicating the date and time. The date and time indicated by the clock unit 402 are referenced by the display unit 405. When the downloading conditions are time-related, the date and time indicated by the clock unit 402 are referenced by the condition determining unit 401.

When the condition determining unit 401 has sent out a notification that the downloading conditions have been satisfied, the sending unit 403 responds by sending a ticket image data download request to the ticket data server 500 via the network. The sending unit 403 may be one of the communication devices described above or an interface for the communication device.

The receiving unit 404 receives ticket image data from the ticket data server 500 via the network. The receiving unit 404 sends the received ticket image data to the display unit 405. The receiving unit 404 may be one of the communication devices described above or an interface for the communication device.

The ticket image data is image data that changes over time. The ticket image data may have any pattern but is preferably a simple pattern that can be recognized at a glance by admission administrators. The changes over time in the ticket image data may include changes in color, brightness, pattern, letters or numbers, or changes in the position or orientation of patterns, letters, or numbers. The ticket image data may also include a portion that does not change. For example, a portion of the ticket image data that does not change over time may be a portion indicating the event name, venue name, and event date and time. The ticket image data may change over time so that the image data does not constantly appear the same from the outside. In this way, clues cannot be obtained about how the ticket image data will appear in the future by examining ticket image data that appeared in the past. This makes it difficult to forge ticket image data based on an illicit screenshot.

When the interval is too short, it may become more difficult for admission administrators to check the ticket image data at a glance. Therefore, the interval can be set to be longer than the period of time required for admission administrators to admit a single group (for example, 3 seconds), or a visual effect can be retained that does not involve a change in the pattern itself, such as blinking ticket image data. When the interval is too long and the ticket image data does not change for a long period of time, it becomes less difficult to forge ticket image data based on an illicit screenshot.

The display unit 405 receives ticket image data from the receiving unit 404 and displays the ticket image data. The display timing for the ticket image data is controlled by the display unit 405 based on the date and time indicated by the clock unit 402. If the time on the clock units 402 between ticket displaying devices 400 is not off, all of the ticket displaying devices 400 are synchronized to display ticket image data, and the changes over time in the ticket image data displayed on all ticketing display devices 400 are the same. In other words, ticket displaying devices 400 that have acquired the same admission rights can display the same ticket image data. Because the ticket image data changes over time based on the date and time indicated by the clock unit 402 inside each ticket displaying device 400, the timing for changing ticket image data may be off if there are discrepancies in the date and time indicated on each clock unit 402. The display unit 405 may be a display device described above or an interface for one of those display devices.

As explained above, the timing for changing the ticket display data is mistimed if the time on the clock units 402 is off between ticket displaying devices 400. In other words, there is a possibility that the ticket image data displayed on the screen of the ticket displaying device 400 of a user with admission rights, that is, a ticket purchaser or admission administrator, let alone that of an unauthorized entrant, will not be the ticket image data that should be currently displayed but rather ticket image data before or after this ticket image data.

Therefore, the display unit 405 of at least one ticket displaying device 400, that of the visitor or the admission administrator, may display not only the current image data associated with the (current) time indicated by the clock unit 402 in the ticket displaying device 400, but also at least one past image data or future image data associated with a time before or after the current time. For example, the previous two versions of past image data and the subsequent two versions of the image data can be displayed. In this way, the admission process remains smooth even when there is a mismatch between the clock units 402 on the ticket displaying devices 400 of visitors and admission administrators. Here, the display unit 405 may display the past image data or the future image data side by side with the current image data or may display the past image data or future image data alternatingly with the current image data.

In order to keep the time from being off on clock units 402 between ticket displaying devices 400, the ticket sales server 300 or ticket data server 500 may note the mistiming of a clock unit 402 in a ticket displaying device 400 when accessed by the ticket displaying device 400 and prompt the device to reset the time if it is off.

An example of the configuration for the ticket data server 500 will now be described. The ticket data server 500 is a server computer including a processor for controlling retrieval of ticket image data and controlling communication, and memory for temporarily storing a program executed by the processor and data used by the processor for realizing this processing.

The ticket data server 500 can use a communication device connected to a network and an auxiliary storage device for storing large amounts of data. The communication device and auxiliary storage device may be built into the ticket data server 500 or may be attached externally to the ticket data server 500.

The communication device communicates with ticket displaying devices 400 or the ticket sales server 300 via the network. For example, the communication device receives ticket purchaser information and key data issuing requests from the ticket sales server 300, receives ticket image data download requests from ticket displaying devices 400, and distributes ticket image data to the ticket displaying devices 400.

The auxiliary storage device is used to store, for example, ticket purchaser information. The auxiliary storage device is preferably a non-volatile storage medium such as an HDD or SSD. The auxiliary storage device may be a file server connected to the ticket data server 500 via a network.

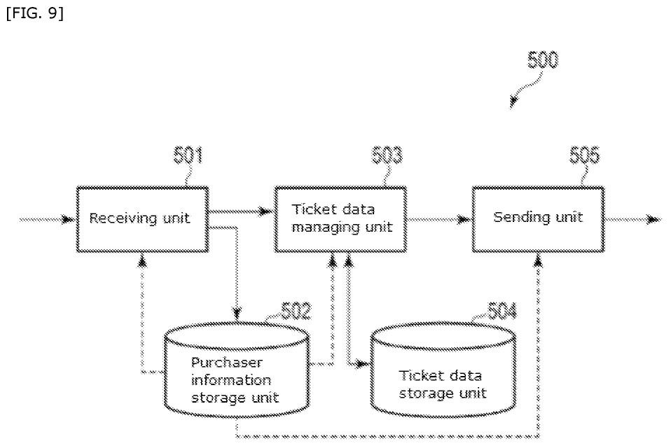

The description of the example of a configuration for the ticket data server 500 will now be continued with reference to FIG. 9. The ticket data server 500 in FIG. 9 includes a receiving unit 501, a purchaser information storage unit 502, a ticket image data managing unit 503, a ticket image data storage unit 504, and a sending unit 505.

The receiving unit 501 receives ticket purchaser information from the ticket sales server 300, and ticket image data download requests from ticket displaying devices 400. The receiving unit 501 may authenticate a ticket displaying device 400 if necessary when a ticket image display download request is received. The receiving unit 501 saves ticket purchaser information to a purchaser information storage unit 502 (not shown). The receiving unit 501 also sends the ticket image data download request to the ticket image data managing unit 503. The receiving unit 501 may be one of the communication devices described above or an interface for the communication device.

The purchaser information storage unit 502 receives ticket purchaser information from the receiving unit 501 and stores the information. The ticket purchaser information is referenced by the receiving unit 501 to authenticate a ticket displaying device 400, and is referenced by the sending unit 505 to set the address for the ticket image data. The purchaser information storage unit 502 may be the auxiliary storage device described above or an interface for the auxiliary storage device.

The ticket image data managing unit 503 receives ticket image download requests from the receiving unit 501 and responds by retrieving the appropriate ticket image data from the ticket image data storage unit 504. The appropriate ticket image data can be identified using information included in the download request. The ticket image data managing unit 503 sends the retrieved ticket image data to the sending unit 505. The ticket image data managing unit 503 may be the processor and memory described above.

The ticket image data storage unit 504 stores ticket image data. The ticket image data storage unit 504 can store different types of ticket image data with different admission rights. The ticket image data may be generated by the ticket image data managing unit 503 or may be generated by an external device (not shown) and received by the receiving unit 501. The ticket image data is retrieved from the ticket image data managing unit 503 and distributed to ticket displaying devices 400. The ticket image data storage unit 504 may be the auxiliary storage device described above or an interface of the auxiliary storage device.

The sending unit 505 receives ticket image data from the ticket image data managing unit 503 and sends this to a ticket displaying device 400 via a network. The sending unit 505 may be a communication device described above or an interface for one of these communication devices.

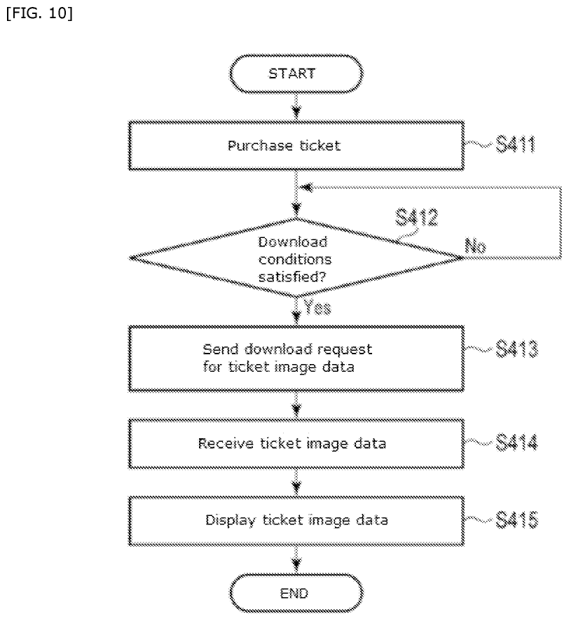

The following is an explanation of the operations performed by a ticket displaying device 400 with reference to FIG. 10. First, the ticket displaying device 400 accesses the ticket sales server 300 to purchase a ticket (Step S411). After Step S411, the ticket sales server 300 sends ticket purchaser information to the ticket data server 500. The ticket data server 500 may send ticket image data downloading conditions to the ticket displaying device 400.

The condition determining unit 401 determines whether or not the downloading conditions have been satisfied (Step S412). As mentioned above, Step S412 may be executed in response to some type of trigger. When the condition determining unit 401 determines that the downloading conditions have been satisfied, the sending unit 403 sends a ticket image data downloading request to the ticket data server 500 (Step S413).

When a ticket image data download request is received, the ticket data server 500 distributes ticket image data to the ticket displaying device 400. The receiving unit 404 in the ticket displaying device 400 receives this ticket image data (Step S414).

The display unit 405 displays the ticket image data received in Step S414 (Step S415). In Step S415, the display timing of the ticket image data is controlled based on the date and time indicated on the clock unit 402. The ticket image data is shared by the ticket displaying devices 400 of all ticket purchasers (and admission administrators). The ticket displaying devices 400 of all ticket purchasers (and admission administrators) display the same ticket image data at the same date and time (that is, the local date and time of the ticket displaying devices 400).

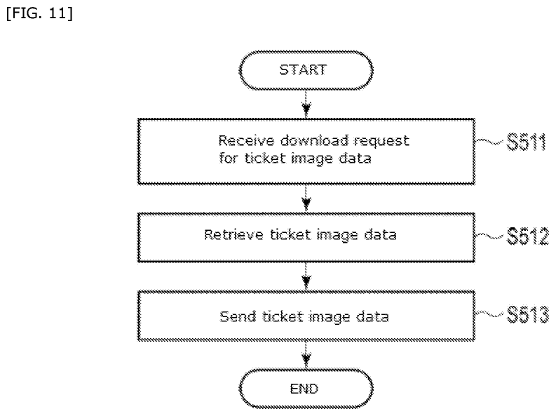

The following is an explanation of the operations performed by the ticket data server 500 with reference to FIG. 11. The receiving unit 501 receives a ticket image data download request from a ticket displaying device 400 (Step S511). Here, the ticket data server 500 may determine whether downloading conditions have been met instead of the ticket displaying device 400.

The ticket image data managing unit 503 retrieves the ticket image data that is the target of the downloading request received in Step S511 from the ticket image data storage unit 504 (Step S512).

The sending unit 505 sends the ticket image data retrieved in Step S512 to the ticket displaying device 400 that is the origin of the downloading request received in Step S511 (Step S513).

In the electronic ticket system of the second embodiment described above, the ticket displaying device of a ticket purchaser downloads and displays ticket image data after the downloading conditions have been satisfied. The display timing for the ticket image data is controlled based on the date and time indicated on the clock unit. This ticket image data is essentially the same as the ticket image data on other ticket displaying devices. Therefore, this ticket image data changes over time in the same way as ticket image data displayed on other ticket displaying devices used to authenticate the same admission rights as this ticket image data. In this electronic ticket system, admission administrators can manage the admission of a plurality of visitors simply by glancing at the screens of the ticket displaying devices of these visitors. Because the ticket image data changes over time, it is difficult to forge ticket image data based on an illicit screenshot. Also, this ticket image data cannot be downloaded unless the downloading conditions have been satisfied, making it more difficult to forge prior to use of the admission rights.

Also, the display unit on the ticket displaying devices of the visitors and/or admission administrators may display not only the current image data associated with the (current) time indicated by the clock unit in the ticket displaying device, but also at least one past image data or future image data associated with a time before or after the current time. In this way, the admission process remains smooth even when there is a mismatch between the clock units on ticket displaying devices.

### Modified Examples

The admission rights for an electronic ticket may allow for readmission. In this case, there is a risk that the visitor will enter, lend the smartphone to another person, and the other person will try to re-enter. In order to prevent unauthorized entry through re-use of an electronic ticket, the ticket image data may be displayed again upon re-entry, that is, re-use of admission rights after the presenter of the ticket displaying device has been authenticated as the owner of the ticket displaying device using biometric authentication such as fingerprint authentication (that is, after passing biometric authentication). Here, the ticket displaying device may include an authentication unit for biometrically authenticating the owner of the ticket displaying device. In an opposite case from the one explained here, the non-owner of a ticket displaying device may enter first, and the owner of the ticket displaying device may then re-enter. As a countermeasure, biometric authentication may be employed during initial entry.

The embodiments described above are mere examples used to explain the general concepts of the present invention and are not intended to limit the scope of the present invention in any way. Embodiments that add, subtract or modify any of these configurational elements in a way that does not depart from the spirit and scope of the present invention are included herein.

The functional units explained in the embodiments described above may be realized using circuits. These circuits may be dedicated circuits used to realize specific functions or general-purpose circuits such as processors.

At least some of the processing in the embodiments described above can be realized on a general-purpose computer using basic hardware. A program for executing this processing may also be stored in a computer-readable storage medium. The program may be stored in the storage medium in an installable file format or in an executable file format. The storage medium may be a magnetic disk, an optical disk (CD-ROM, CD-R, DVD, etc.), a magneto-optical disk (MO, etc.), or semiconductor memory. The storage medium can be any medium able to store programs in a computer-readable manner. The program used to execute the processing may also be stored in a computer (server) connected to a network such as the internet and downloaded to a computer (client) via the network.

1. A ticket displaying device comprising:
a clock unit configured to indicate the date and time;
a receiving unit configured to receive first key data,
wherein, after purchase of a ticket by a first ticket purchaser, the first key data is generated by a key data server based on first ticket purchaser identifying information, and
wherein the first ticket purchaser identifying information corresponds to the ticket displaying device or the identity of the first ticket purchaser;
a generating unit configured to:
generate a first seed code corresponding to the first ticket purchaser identifying information and the first key data; and
periodically generate first ticket image data for authenticating admission rights on the basis of the date and time indicated by the clock unit and the first seed code; and
a display unit configured to display, when the first key data is provided, the first ticket image data,
wherein the first ticket image data displayed on the display unit changes over time based on the date and time indicated by the clock unit,
wherein, after the purchase of the ticket by a first ticket purchaser, the key server generates a second key data corresponding to a second ticket displaying device or the identity of a second ticket purchaser,
wherein a second seed code, which is identical to the first seed code, is generated using the second ticket purchaser identifying information and the second key data,
wherein, when the date and time indicated by the clock unit of the ticket displaying device coincides with a date and time indicated by a second clock unit of a second ticket displaying device, the first ticket image data is displayed on the second ticket displaying device using the date and time and the second seed code, and
wherein the first ticket image data displayed on the display unit shows the same changes over time as second ticket image data displayed on the second ticket displaying device for authenticating the same admission rights as the first ticket image data.

2. A ticket displaying device comprising:
a clock unit configured to indicate the date and time;
a sending unit configured to send a download request for ticket image data for authenticating admission rights to a server when predetermined conditions are satisfied;
a generating unit configured to:
generate a first seed code corresponding to a first ticket purchaser identifying information and a first key data; and
periodically generate a first ticket image data;
a receiving unit configured to receive the first ticket image data for authenticating admission rights from the server, wherein the first ticket image data is based on the date and time indicated by the clock unit and a first seed code; and
a display unit configured to display, when the first key data is provided, the first ticket image data,
wherein, after purchase of a ticket by the first ticket purchaser, the first key data is generated by a key data server based on first ticket purchaser identifying information,
wherein, after purchase of the ticket by the first ticket purchaser, a second key data is generated by the key data server based on a second ticket displaying device or the identity of a second ticket purchaser,
wherein the second key data is different from the first key data,
wherein a second seed code, which is identical to the first seed code, is generated using second ticket purchaser identifying information and the second key data,
wherein, when the date and time indicated by the clock unit of the ticket displaying device coincides with a date and time indicated by a second clock unit of the second ticket displaying device, the first ticket image data is displayed on the second ticket displaying device using the date and time and the second seed code,
wherein the first ticket image data displayed on the display unit changes over time,
wherein the first ticket image data has display timing controlled on the basis of the date and time indicated by the clock unit, and
wherein the first ticket image data displayed on the display unit shows the same changes over time as second ticket image data displayed on the second ticket displaying device for authenticating the same admission rights as the first ticket image data.

3. A ticket displaying device according to claim 1, wherein the change over time in the first ticket image data displayed on the display unit includes changes in color, brightness, pattern, letters or numbers, or changes in the position or orientation of patterns, letters, or numbers.

4. A ticket displaying device according to any one of claims 1, wherein the first ticket image data displayed on the display unit changes over time so that the image data does not repeatedly have the same appearance.

5. A ticket displaying device according to any one of claims 1, wherein the display unit can display side by side or alternatively switch on the same screen the current image data associated with the date and time indicated by the clock unit in the first ticket image data, and at least one of the previous image data or subsequent image data associated with the date and time before or after the date and time indicated by the clock unit in the first ticket image data.

6. A ticket displaying device according to any one of claims 1, further comprising an authenticating unit for performing biometric authentication of an owner of the ticket displaying device, the display unit no longer displaying the first ticket image information for reuse of admission rights if the owner does not pass the biometric authentication performed by the authenticating unit.

7. (canceled)

8. (canceled)

9. (canceled)

10. A ticket display program causing a computer to function as
a sending unit configured to send a download request for ticket image data for authenticating admission rights to a server when predetermined conditions are satisfied;
a generating unit configured to:
generate a first seed code corresponding to a first ticket purchaser identifying information and a first key data; and
periodically generate a first ticket image data;
a receiving unit configured to receive the first ticket image data for authenticating admission rights from the server, wherein the first ticket image data is based on the date and time indicated by a first clock unit of the computer and the first seed code; and
a display unit configured to display, when the first key data is provided, the first ticket image data,
wherein, after purchase of a ticket by the first ticket purchaser, the first key data is generated by a key data server based on first ticket purchaser identifying information,
wherein, after purchase of the ticket by the first ticket purchaser, a second key data is generated by the key data server based on a second computer or the identity of a second ticket purchaser,
wherein the second key data is different from the first key data,
wherein a second seed code, which is identical to the first seed code, is generated using second ticket purchaser identifying information and the second key data,
wherein, when the date and time indicated by the first clock unit of the computer coincides with a date and time indicated by a second clock unit of a second computer, the first ticket image data is displayed on a display unit of the second computer using the date and time and the second seed code,
wherein the first ticket image data displayed on the display unit changes over time,
wherein the first ticket image data has display timing controlled on the basis of the date and time indicated by the first clock unit, and
wherein the first ticket image data displayed on the display unit shows the same changes over time as second ticket image data for authenticating the same admission rights as the first ticket image data displayed on the display unit of the second computer executing the ticket display program.
